(19) United States
(12) Patent Application Publication
(10) Pub. No.: US 2024/0418146 A1
(43) Pub. Date: Dec. 19, 2024

(54) Rotor for a Vertical Axis Turbine and Vertical Axis Turbine

(71) Applicant: Blown B.V., Sint-Annaland (NL)

(72) Inventors: Eric Gerardus Maria Caron, Breda (NL); Maarten Cornelis van Oeveren, Sint-Annaland (NL)

(21) Appl. No.: 18/701,801

(22) PCT Filed: Oct. 13, 2022
(86) PCT No.: PCT/NL2022/050587

§ 371 Date: Apr. 16, 2024

(30) Foreign Application Priority Data
Oct. 18, 2021 (NL) 2029458

(51) Int. Cl. F03D 3/06; F03B 17/06; F03D 3/00

(52) U.S. Cl. CPC F03D 3/067; F03B 17/065; F03D 3/005; F05B 2210/16; F05B 2240/215; F05B 2260/72; F05B 2260/964

(57) ABSTRACT

The invention relates to a rotor for a vertical axis turbine comprising: —a blade support structure extending from a center of the rotor, —a blade pivotally coupled to the blade support structure at a distance from the center of the rotor, and—a pitch regulating mechanism arranged between the blade support structure and the blade to regulate the pitch of the blade in dependence of fluid dynamic forces acting on the blade, wherein the pitch regulating mechanism comprises a damper system, wherein the damper system has a first damping coefficient in a first rotational direction of the blade relative to the blade support structure and a second damping coefficient in a second rotational direction of the blade relative to the blade support structure.

### BACKGROUND OF THE INVENTION

The invention relates to a rotor for a vertical axis turbine such as a wind turbine or underwater turbine, and a vertical axis turbine including such a rotor.

A turbine in the context of this application is used to extract energy from wind or water current by converting kinetic energy from the wind or water into kinetic energy of a rotor, and then possibly into other forms of energy, for instance electrical energy, although this is not necessary per se, and the turbine may also be used for amusement or promotional purposes. Turbines, e.g., wind turbines, come in two types, namely well-known horizontal axis turbines having the main rotor shaft extending horizontally and vertical axis turbines having the main rotor shaft extending vertically.

In turn, vertical axis turbines can generally be divided into two types as well, namely those comprising Savonius-type rotors and those comprising Darrieus-type rotors. The Savonius-type works mainly on the basis of a difference in drag, thereby limiting the maximum efficiency. The benefit of this type of turbine, however, is its simplicity in design and the fact that it will start operating automatically once it captures enough wind or water. The Darrieus-type, on the other hand, operates on the basis of lift generated over the blades, which enables higher relative speeds and a higher efficiency.

It is well-recognized that the rotor of a vertical axis turbine of the Darrieus-type, due to the higher relative speeds, is subjected to higher forces and torques. The blades are subjected to lift and drag forces caused by the relative movement of the blade through the medium, i.e., air or water. Turbulent flows, e.g., the passing of strong wind gusts for a wind turbine, may introduce extreme and potentially destructive, forces on the blades and rotor. Further, the blades are subjected to centrifugal forces that increase with increasing relative speeds.

Other drawbacks of vertical axis turbines may include difficult/impossible self-starting, lower output due to operation closer to the ground, and higher level of vibration caused by the inherent torque ripple and dynamic stall of the blades, at least in the “small wind” domain.

### SUMMARY OF THE INVENTION

In view of the above it is an object of the invention to provide an improved vertical axis turbine.

According to an embodiment of the invention, there is provided a rotor for a vertical axis turbine comprising:
a blade support structure extending from a center of the rotor,
a blade pivotally coupled to the blade support structure at a distance from the center of the rotor, and
a pitch regulating mechanism arranged between the blade support structure and the blade to regulate the pitch of the blade in dependence of fluid dynamic forces acting on the blade,
   wherein the pitch regulating mechanism comprises a damper system, wherein the damper system has a first damping coefficient in a first rotational direction of the blade relative to the blade support structure and a second damping coefficient in a second rotational direction of the blade relative to the blade support structure.

In an embodiment, the blade is configured to be oriented—or comprise at least a portion that is—substantially parallel to a vertical rotation axis of the rotor. The blade may be oriented in a substantial helical shape or be part of a contour of a balloon or sphere around the vertical rotation axis of the rotor. In some embodiments, the blade support is an, preferably integrated, extension of the blade extending from a center of the rotor to the substantially vertically oriented blade. Such an extension may be provided at both ends of the blade.

The rotor may define an advancing rotational direction in which the rotor will rotate during operation. The first rotational direction of the blade relative to the blade support may be in the same direction as the advancing rotational direction in which case the second rotational direction of the blade relative to the blade support is in an opposite direction to the advancing rotational direction.

The damping coefficient is defined as the ratio between a force generated by the damper system as a result of a relative speed between two components of the damper system. The higher the relative speed, the higher the generated force.

In an embodiment, the first damping coefficient is higher than the second damping coefficient.

In an embodiment, the second damping coefficient is substantially zero.

In an embodiment, the blade and the pitch regulating mechanism form a blade combination, wherein the rotor comprises two or more such blade combinations distributed, preferably evenly distributed about the center of the rotor. In an embodiment, the pitch regulating mechanisms of two or more blade combinations are integrated with each other and/or part of a common pitch regulating system.

In an embodiment, the damper system has a third damping coefficient over a first distance in the first rotational direction of the blade, wherein the first damping coefficient applies to a second distance in the first rotational direction of the blade, said second distance being adjacent to the first distance. The third damping coefficient may be substantially equal to the second damping coefficient and/or the third damping coefficient may be substantially zero. Preferably, when reversing direction from the second rotational direction to the first rotational direction the blade first rotates over the first distance in the first rotational direction and subsequently over the second distance. Hence, preferably, the third damping coefficient is applied first before the first damping coefficient is applied when rotating in the first rotational direction.

In an embodiment, the rotor further comprises a lower support to be mounted to a shaft, pole, or beam, and a lower bearing arranged between the lower support and the blade support allowing the blade support to rotate relative to the lower support.

In an embodiment, the rotor further comprises an upper support to be mounted to a shaft, pole or beam, and an upper bearing arranged between the upper support and the blade support allowing the blade support to rotate relative to the upper support.

To be mounted to the shaft, pole or beam means that the lower and/or upper support are mountable to the shaft, pole, or beam to transfer at least horizontal loads to the shaft, pole, or beam. Preferably, the lower and/or upper support are also mountable to the shaft, pole, or beam to transfer vertical loads to the shaft, pole, or beam.

In an embodiment, a (separate) bearing, preferably a sliding bearing, is provided to be arranged between the blade support and the shaft, pole, or beam to transfer horizontal loads to the shaft, pole, or beam. The bearing may be provided at any location but is preferably combined with the above-described lower support (including lower bearing) with the bearing being provided above the lower support at a distance from the lower support, or with the above-described upper support (including upper bearing) with the bearing being provided below the upper support at a distance from the upper support.

In an embodiment, the rotor is configured such that the orientation of a blade relative to the blade support is mainly determined by fluid dynamic forces, damping forces applied by the damper system and/or frictional forces. Any resilient, elastic or spring forces present in the rotor during operation are then significantly smaller, e.g., absent, preferably significantly smaller than a combination of the other forces, e.g., at most 50% of the combination of the other forces, preferably at most 30% of the combination of the other forces, more preferably at most 20% of the combination of the other forces, and most preferably at most 10% of the combination of the other forces. The resilient, elastic or spring forces being smaller may additionally or alternatively mean that their maximum value is below 50% of the maximum value of the damping forces applied by the damper system, preferably below 30%, more preferably below 20% and most preferably below 10% of the maximum value of the damping forces applied by the damper system. It is for instance envisaged that a spring is used to prevent damage of the blade. The blade may have a center position, for instance defined by a position in which the blade or a portion thereof is tangent to a circle around the center of the rotor, and two extreme rotational positions, wherein the spring is provided to urge the blade towards its center position when reaching one of the extreme rotational positions to prevent a hard stop and thus damage to the blade or blade support.

In an embodiment, the pitch regulating mechanism is devoid of springs and elements providing spring forces. Hence, springs or elements providing spring forces may be absent.

In an embodiment, the blade has a leading edge and a trailing edge, and the blade has a center of gravity, wherein the pivot axis defined by the blade support structure is located between the center of gravity and the leading edge of the blade.

In an embodiment, the damper system comprises a damper in which a fluid is forced through a fluid resistance, which fluid resistance is variable. Providing a variable fluid resistance can be done in various ways. A passive way is to provide a one-way valve with a small aperture, so that when the one-way valve is closed, the fluid is forced through the small aperture resulting in a high fluid resistance and thus a high damping coefficient, and when the one-way valve is open (corresponding to an opposite fluid flow direction), the fluid is forced through a relatively large opening resulting in a low fluid resistance and thus a high damping coefficient. The fluid may be a liquid or a gas, e.g. a hydraulic fluid.

Alternatively, it is possible to use active control to vary the fluid resistance, for instance by actively controlling a valve, e.g. a pneumatic valve, or by adjusting a resistance of electrical actuators thereby adjusting the amount of energy dissipation of the electrical actuators.

In an embodiment, the damper extends between the blade support and the leading edge of the blade.

In an embodiment, the blade comprises a damper support extending from the leading edge of the blade, and the damper extends between the blade support and the damper support on the blade.

According to a further embodiment of the invention, there is provided a vertical axis turbine comprising a rotor according to the invention. The rotor may be mounted to a pole, shaft, beam or other constructional member to rotate about a rotation axis defined by the pole, shaft, beam, or other constructional member.

In an embodiment, the turbine is a wind turbine to extract energy from the wind. In another embodiment, the turbine is a water turbine to extract energy from water currents.

In an embodiment, the turbine further comprises a rotation speed limiting device to limit the maximum rotational speed of the rotor. The rotation speed limiting device may be passive, e.g., including a control element that is subjected to centrifugal forces against a spring and is configured to reduce or limit the net torque to the rotor once a predetermined rotational speed is achieved.

In an embodiment, the rotation speed limiting device is active, including a sensor for measuring a rotational speed of the rotor and an actuator for actively reducing or limiting the speed, e.g., by dissipating excess energy, for instance by using mechanically braking or electrically braking using a generator connected to the rotor.

In an embodiment, the rotation speed limiting device is connected to or integrated with the pitch regulating device to adjust the working of the pitch regulating device once a predetermined rotational speed is achieved to reduce or limit the rotational speed of the rotor.

It is noted here explicitly that the inventors acknowledge, as will all persons skilled in the art of engineering, that ideal springs and dampers do not exist in practice. Hence, springs will dissipate some energy in practice and thus have a non-zero damping coefficient and dampers or other components of the rotor will not have an infinite stiffness in practice and thus will have a non-zero spring constant. Statements as a zero damping coefficient or devoid of springs thus have to be interpreted within this practical context as respectively meaning that energy dissipation is minimal as reasonably can be expected and that no elements have been employed to provide a significant resilient behavior of the pitch of the blade.

### BRIEF DESCRIPTION OF THE DRAWINGS

The invention will now be described in a non-limiting way by reference to the accompanying drawings in which like parts are indicated by like reference symbols, and in which:

FIG. 1 schematically depicts a perspective view of a turbine according to an embodiment of the invention,

FIG. 2A schematically depicts a top view of a rotor according to an embodiment of the invention in a first rotational position,

FIG. 2B schematically depicts a top view of the rotor of FIG. 2A in a second rotational position,

FIG. 2C schematically depicts a top view of the rotor of FIG. 2A in a third rotational position,

FIG. 2D schematically depicts a top view of the rotor of FIG. 2A in a fourth rotational position,

FIG. 2E schematically depicts a top view of the rotor of FIG. 2A in a fifth rotational position,

FIG. 2F schematically depicts a top view of the rotor of FIG. 2A in a sixth rotational position,

FIG. 2G schematically depicts a top view of the rotor of FIG. 2A in a seventh rotational position,

FIG. 2H schematically depicts a top view of the rotor of FIG. 2A in an eighth rotational position,

FIG. 2I schematically depicts a top view of the rotor of FIG. 2A in a ninth rotational position,

FIG. 3 schematically depicts a diagram of a torque generated by a blade of the rotor of FIG. 2A as a function of the rotational position, and

FIG. 4 schematically depicts a cross-sectional view of an upper portion and lower portion of the rotor of the wind turbine of FIG. 1 on a pole.

### DETAILED DESCRIPTION OF THE INVENTION

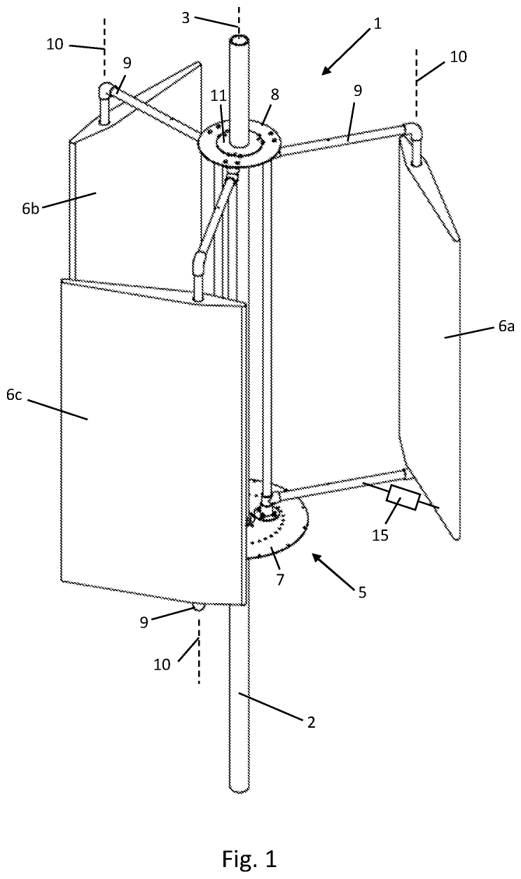

FIG. 1 schematically depicts a perspective view of a wind turbine 1 according to an embodiment of the invention. The wind turbine 1 is of the vertical axis type and includes a pole 2 having a longitudinal axis 3 extending substantially parallel to the vertical. The pole 2 may be designed as part of the wind turbine 1, but it is also possible that pole 2 is an already present element originally used for other purposes, e.g., a flagpole, and the wind turbine 1 is formed by mounting a rotor 5 to the pole 2. In this example, the longitudinal axis 3 of the pole 2 coincides with a vertical rotation axis of the rotor.

In other embodiments, the pole 2 may alternatively be a beam, mast, shaft or any other element allowing to mount a rotor to and to provide a vertical rotation axis for the rotor.

The rotor 5 comprises three blades 6a, 6b, 6c and a blade support structure for supporting the three blades 6a, 6b, 6c. The blade support structure in this example includes a lower member 7, an upper member 8 and a respective frame 9 for each of the three blades 6a, 6b, 6c. The respective frames 9 are connected to the lower member 7 and the upper member 8, and each blade 6a, 6b, 6c is pivotally connected to a respective frame 9 allowing the corresponding blade 6a, 6b, 6c to pivot about a pivot axis 10 extending substantially parallel to the longitudinal axis 3, hence, substantially parallel to the vertical rotation axis of the rotor 1.

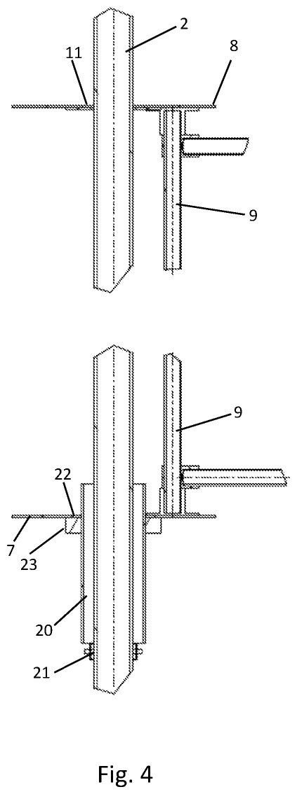

In the embodiment of FIG. 1, the upper member 8 is connected to a bearing 11, in this embodiment a sliding bearing 11, to engage with the pole 2. The bearing 11 is configured to transfer horizontal forces between the rotor 5 and the pole 2 to guide rotation of the rotor about the pole 2. In this embodiment, the bearing 11 is not configured to transfer vertical forces between the rotor 5 and the pole 2. Vertical and horizontal forces are transferred between the rotor 5 and the pole 2 using a construction at the lower member 7, which construction will be explained in more detail below by reference to FIG. 4.

Arranged between the blade support structure and the blades 6a, 6b, 6c is a pitch regulating mechanism 15, which is only visible in FIG. 1 for blade 6a. The pitch regulating mechanism 15 is configured to regulate the pitch of the respective blade in dependence of fluid dynamic forces on the blade. The pitch regulating mechanism comprises a damper system, wherein the damper system has a first damping coefficient in a first rotational direction and a second damping coefficient in a second rotational direction. An advantage of the different damping coefficient for different rotational directions is that the pitch behavior of a blade during a complete 360 degrees rotation of the rotor can be optimized to deal with different drawbacks and operating conditions of this type of vertical axis wind turbine. For instance, the first damping coefficient may be optimized to deal with the passing of strong wind gusts and/or centrifugal forces, while the second damping coefficient may be optimized to deal with easy self-starting and torque generation as will be explained below in more detail by reference to other embodiments.

Although the pitch regulating mechanism is indicated as an externally visible component between the frame 9 and the blade 6a, the pitch regulating mechanism may at least be partially hidden, e.g., integrated into the blade 6a and/or the frame 9, which has the advantage that the pitch regulating mechanism does not or minimally interfere with the fluid dynamic forces acting on the rotor 5.

Each of the blades 6a, 6b, 6c and their corresponding pitch regulating mechanisms form a blade combination. The rotor 5 includes in this embodiment three blade combinations distributed evenly about the center of the rotor 5. However, another number of blade combinations is also envisaged.

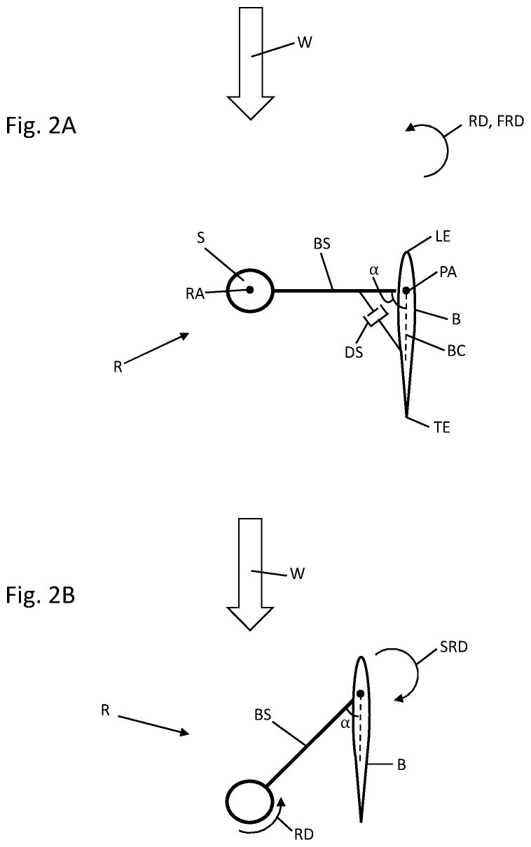

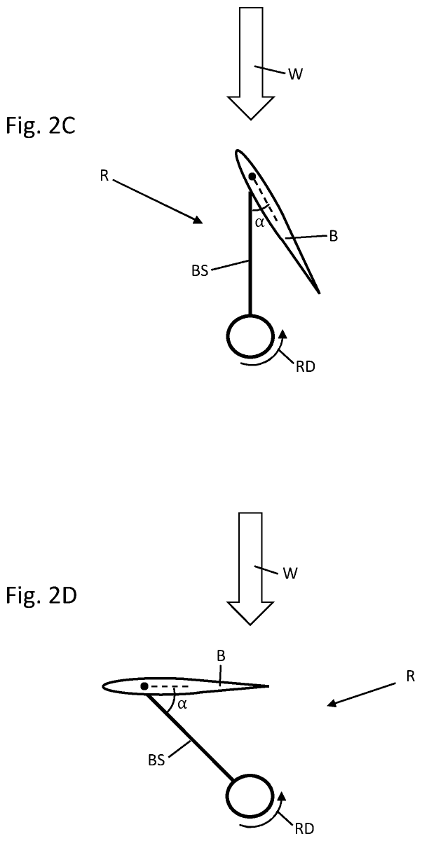

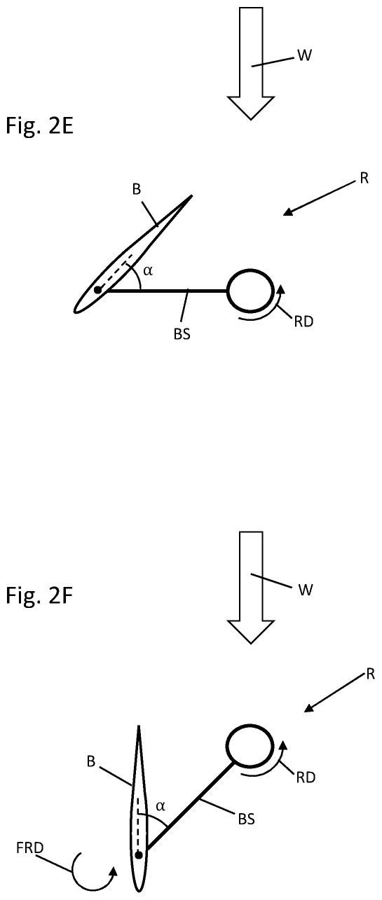

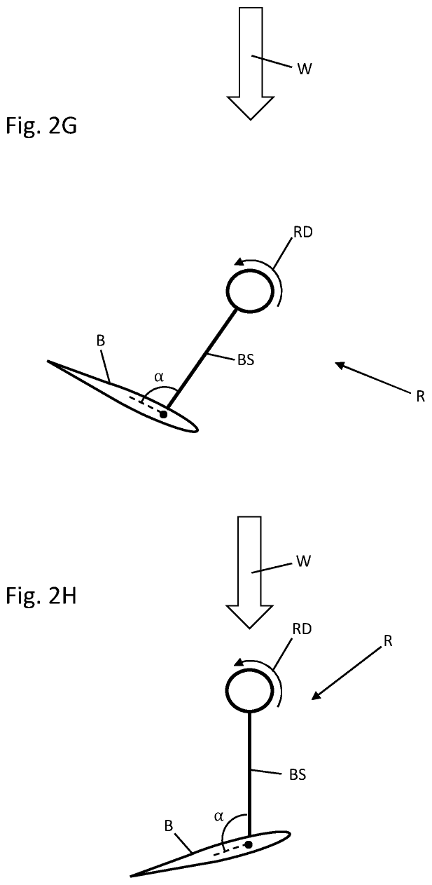

FIGS. 2A-2I schematically depict a top view of a simplified representation of a rotor R according to an embodiment of the invention, wherein each drawing of the FIGS. 2A-2I depicts the rotor R in a different rotational position. The rotor R includes a support S at a center of the rotor R defining a vertical rotation axis RA, a blade support structure BS extending from the support S of the rotor R, and a blade B pivotally coupled to the blade support structure BS at a distance from the center of the rotor R to pivot about a pivot axis PA, wherein the blade B is configured to be oriented substantially parallel to the vertical rotation axis RA of the rotor R. Arranged between the blade B and the blade support structure BS is a damper system DS as part of a pitch regulating mechanism.

The rotor R shows similarities with the rotor 5 of FIG. 1. Hence, the support S may correspond to or comprise components similar to the pole 2 and the bearing 11 and/or the construction at lower member 7. The blade support structure BS may correspond to or comprise components similar to the lower member 7, the upper member 8 and the frame 9. The blade B may correspond to one of the blades 6a, 6b, 6c and the pivot axis PA may correspond to pivot axis 10. The pitch regulating mechanism 15 in FIG. 1 may be or comprise the damper system DS of FIGS. 2A-2I.

The different rotational positions of the rotor R as depicted in the FIGS. 2A-2I in combination with a constant wind direction W of constant magnitude will be used below to explain the behavior of the rotor R, in particular the behavior of the blade B, more in particular the behavior of the pitching of the blade B, which may also apply to each blade of the rotor 5 of FIG. 1.

Below, reference will be made to a pitch angle α of a blade, which pitch angle α will be defined by reference to a top view as in FIGS. 2A-2I as the angle between a straight line connecting the vertical rotation axis RA of the rotor R and the pivot axis PA of the blade B, in this embodiment coinciding with the blade support structure BS, and a trailing edge TE side of a straight line joining a leading edge LE of the blade B with its trailing edge TE also known as the blade chord BC.

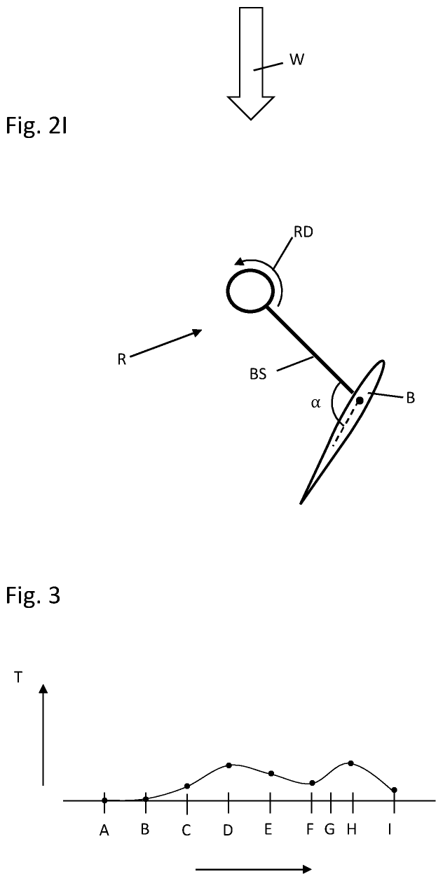

When discussing the behavior of the rotor R for different rotational positions of the rotor R as depicted in the FIGS. 2A-2I, reference will also be made to FIG. 3 indicating the generated torque T as a function of rotational position, wherein the reference symbol A-I correspond to the rotational position of FIGS. 2A-2I.

Further, for simplicity reasons, the rotation axis RA and the damper system DS are only depicted in FIG. 2A and will be omitted in the other FIGS. 2B-2I.

In FIG. 2A, the rotor R is in a first rotational position with the pitch angle α of blade B being substantially 90 degrees and the blade chord BC being parallel to the wind direction W. This first rotational position may alternatively be referred to as the 0-degree rotational position. The rotor R defines an advancing rotational direction, in this case a rotational direction indicated by arrow RD in which blade B will move in a direction parallel to a direction from trailing edge TE to leading edge LE.

The blade B can pivot in two rotational directions about the pivot axis PA relative to the blade support structure BS. The rotational direction corresponding to the advancing rotational direction RD will be referred to as the first rotational direction FRD, and the rotational direction in opposite direction to the advancing rotational direction will be referred to as the second rotational direction SRD.

In the first rotational position of FIG. 2A, the torque T generated by blade B is zero or at least minimal as shown in FIG. 3.

In FIG. 2B, the rotor R has rotated in the advancing rotational direction RD to a second rotational position. The wind W will cause the blade to rotate in the second rotational direction SRD relative to the blade support structure BS thereby making the pitch angle α smaller and keeping the orientation of the blade B substantially aligned with the wind W. As a result, the torque T generated in the second rotational position B is minimal.

In FIG. 2C, the rotor R has rotated in the advancing rotational direction RD to a third rotational position. The blade B will have a minimal pitch angle α but will start to rotate relative to the wind W. The rotational speed of the rotor R in combination with the wind W will cause lift and drag forces on the blade B resulting in a net torque T about the rotation axis RA of the rotor R.

This torque T will increase to a local maximum when the rotor R rotates in the advancing rotational direction RD to a fourth rotational position as shown in FIG. 2D and subsequently decrease when the rotor R rotates in the advancing rotational direction RD to a fifth rotational position as shown in FIG. 2E, and a sixth rotational position as shown in FIG. 2F.

In the sixth rotational position of FIG. 2F, both centrifugal forces as well as the wind W will cause the blade B to start rotating in the first rotational direction FRD relative to the blade support structure BS. This may happen relatively quickly, so that the pitch angle α increases quickly to a value larger than 90 degrees when the rotor R rotates in the advancing rotational direction RD to a seventh rotational position as shown in FIG. 2G. The pitch angle α will then remain substantially constant when moving to an eighth rotational position as shown in FIG. 2H and a ninth rotational position as shown in FIG. 2I and then return gradually to the first rotational position of FIG. 2A to start a new cycle. The increase in pitch angle ox will also cause an increase in generated torque as shown in FIG. 3 but will then decrease to a minimum as described in relation to the first rotational position of FIG. 2A.

The damper system DS is configured to provide a different damping behavior depending on the rotational direction of the blade B relative to the blade support BS. In the first rotational direction FRD, i.e., for an increasing pitch angle α, the provided damping coefficient (here referred to as first damping coefficient) is larger than the provided damping coefficient (here referred to as second damping coefficient) in the second rotational direction SRD, i.e., for a decreasing pitch angle α. The second damping coefficient is preferably substantially zero. The damper system DS may comprise a damper in which a fluid is forced through a fluid resistance, e.g., a relatively small aperture, which fluid resistance is provided in a one-way valve, so that moving the fluid in one direction corresponds to a closed one-way valve and thus application of the fluid resistance and moving the fluid in opposite direction corresponds to an open one-way valve and thus application of a low, preferably zero fluid resistance.

The damper system DS may include a stop to set a minimum pitch angle α and/or a stop to set a maximum pitch angle α.

During a cycle as described in relation to FIGS. 2A-2I and starting from the first rotational position shown in FIG. 2A, the pitch angle α first decreases. Subsequently, the pitch angle α increases. The damper system DS may be configured to apply a third damping coefficient over a predetermined pitch angle change Ax when the blade B starts to rotate in the first rotational direction FRD which may alternatively be referred to as a first distance. The third damping coefficient is preferably smaller than the first damping coefficient, possibly equal to the second damping coefficient. After rotating over the predetermined pitch angle change Ax in the first rotational direction FRD, the first damping coefficient applies. This subsequent pitch angle range after the predetermined pitch angle change may alternatively be referred to as second distance.

The provision of a smaller third damping coefficient (compared to the first damping coefficient) has the advantage that initially a higher acceleration of the blade in the first rotational direction FRD is allowed which aids in overcoming any static and/or dynamic friction that may be present in the damper system DS. A low, e.g., zero, third damping coefficient may easily be provided by connecting a damper with sufficient play to the blade B and/or blade support BS, said play setting the predetermined pitch angle change Δα.

FIG. 4 schematically depicts a cross-sectional view of two portions of the pole 2 of the wind turbine 1 of FIG. 1 to indicate how the rotor of the wind turbine 1 of FIG. 1 is supported by the pole 2 in an embodiment. Shown is an upper portion of the wind turbine with the upper member 8 and the bearing 11. The upper member 8 is part of the blade support and is connected to the frame 9. Hence, the blade connected to the frame 9 transfers forces and torques to the blade support, in this case the frame 9, which in turn transfers forces and torques to the upper member 8. The bearing 11 is a sliding bearing having an opening matching, including some fabrication and/or assembly tolerances, the diameter of the pole 2. The bearing 11 is able to transfer horizontal loads to the pole 2.

Also shown is a lower portion of the wind turbine with the lower member 7 connected to a construction including a support 20 mounted to the pole 2 using a bolt connection 21, and a bearing assembly with a first bearing part 22 and a second bearing part 23.

The bearing assembly is arranged between the lower member 7 and the support 20. The support 20 is stationary mounted to the pole 2. The first bearing part 22 is similar to the bearing 11 at the upper portion and comprises an opening matching, including some fabrication and/or assembly tolerances, the diameter of the support 20. The first bearing part 22 is configured to transfer horizontal forces between the rotor and the pole 2 (via the support 20). The first bearing part 22 is a sliding bearing.

The second bearing part 23 is configured to transfer vertical forces between the rotor and the pole 2 (via the support 20). The second bearing part 23 may be a roller bearing with a part connected to the lower member 7 and another part connected to the support 20 with balls in between the two parts to reduce friction.

Although in the shown embodiments, vertical forces are only transferred to the pole at a single location, it is possible that at the location of bearing 11 a similar construction is provided. However, transferring both vertical and horizontal loads is preferred at least at the lower portion as it makes it easier to connect the rotor to e.g., a generator below the rotor.

A generator may be connected to the rotor to convert kinetic energy from the rotating rotor into electrical energy. However, the generator may be omitted allowing the rotor to rotate freely, e.g., for commercial or promotional purposes, or the generator may be replaced by another energy conversion device. Other energy conversion devices may provide pressure, thermal energy, chemical energy, motion energy, gravitational energy, etc.

Although the above embodiments have been described as a wind turbine, the same applies to a water turbine.

1. A rotor for a vertical axis turbine comprising:
a blade support structure extending from a center of the rotor,
a blade pivotally coupled to the blade support structure at a distance from the center of the rotor, and
a pitch regulating mechanism arranged between the blade support structure and the blade to regulate the pitch of the blade in dependence of fluid dynamic forces acting on the blade,
wherein
the pitch regulating mechanism comprises a damper system, wherein the damper system has a first damping coefficient in a first rotational direction of the blade relative to the blade support structure and a second damping coefficient in a second rotational direction of the blade relative to the blade support structure.

2. The rotor according to claim 1, wherein the rotor defines an advancing rotational direction in which the rotor will rotate during operation, wherein the first rotational direction of the blade relative to the blade support is in the same direction as the advancing rotational direction, and wherein the second rotational direction of the blade relative to the blade support is in an opposite direction to the advancing rotational direction.

3. The rotor according to claim 1, wherein the first damping coefficient is higher than the second damping coefficient.

4. The rotor according to claim 1, wherein the second damping coefficient is substantially zero.

5. The rotor according to claim 1, wherein the blade and the pitch regulating mechanism form a blade combination, and wherein the rotor comprises two or more such blade combinations distributed about the center of the rotor.

6. The rotor according to claim 1, wherein the damper system has a third damping coefficient over a first distance in the first rotational direction of the blade, wherein the first damping coefficient applies to a second distance in the first rotational direction of the blade, said second distance being adjacent to the first distance.

7. The rotor according to claim 6, wherein the third damping coefficient is substantially equal to the second damping coefficient and/or the third damping coefficient is substantially zero.

8. The rotor according to claim 1, wherein the pitch regulating mechanism is devoid of springs or elements providing spring forces.

9. The rotor according to claim 1, wherein the blade has a leading edge and a trailing edge, and the blade has a center of gravity, and wherein the pivot axis defined by the blade support structure is located between the center of gravity and the leading edge of the blade.

10. The rotor according to claim 1, wherein the rotor is configured such that the orientation of a blade relative to the blade support is mainly determined by fluid dynamic forces, damping forces applied by the damper system and/or frictional forces.

11. A vertical axis turbine comprising a pole, shaft or beam, and [a] the rotor according to claim 1 mounted to said pole, shaft, or beam.

12. The vertical axis turbine according to claim 11, wherein the turbine is a wind turbine.

13. The vertical axis turbine according to claim 11, wherein the turbine is a water turbine.

14. The vertical axis turbine according to claim 11, further comprising a rotation speed limiting device to limit the maximum speed of the rotor.

15. The vertical axis turbine according to claim 14, wherein the rotation speed limiting device is passive.

16. The vertical axis turbine according to claim 14, wherein the rotation speed limiting device is active.

17. The vertical axis turbine according to claim 14, wherein the rotation speed limiting device is connected to or integrated with the pitch regulating device to adjust the working of the pitch regulating device once a predetermined rotational speed is achieved to reduce or limit the rotational speed of the rotor.
